(19) United States
(12) Patent Application Publication
(10) Pub. No.: US 2024/0328393 A1
(43) Pub. Date: Oct. 3, 2024

(54) METHOD AND DEVICE FOR MONITORING A MACHINE STATE OF A MACHINE SYSTEM, IN PARTICULAR A WIND POWER PLANT

(71) Applicant: Bachmann GmbH, Feldkirch (AT)

(72) Inventor: Michael SCHULZ, Rudolstadt (DE)

(21) Appl. No.: 18/619,719

(22) Filed: Mar. 28, 2024

(30) Foreign Application Priority Data
Apr. 3, 2023 (DE) 102023108445.3

(51) Int. Cl. F03D 17/00

(52) U.S. Cl. CPC F03D 17/015; F03D 17/024; F05B 2260/80; F05B 2270/333; F05B 2270/334

(57) ABSTRACT

A method for monitoring a machine state of a machine system, in particular a wind power plant, may include the steps of providing a time series of measured natural vibration spectra of the machine system, detecting a deformation parameter in at least one monitoring time interval, wherein the deformation parameter is characteristic of a deviation of the measured natural vibration spectra from a reference natural vibration spectrum of at least one reference machine system, detecting a noise parameter at the at least one monitoring time interval, wherein the noise parameter is characteristic of a noise of the measured natural vibration spectra, and determining the machine state from the deformation parameter and the noise parameter. A monitoring apparatus for monitoring a machine state of a machine system, in particular a wind power plant, is also described.

### CROSS REFERENCE TO RELATED APPLICATIONS

This application claims the benefit under 35 U.S.C. § 119 (a) of German Patent Application No. DE 10 2023 108 445.3, filed Apr. 3, 2023 entitled METHOD AND DEVICE FOR MONITORING A MACHINE STATE OF A MACHINE SYSTEM, IN PARTICULAR A WIND POWER PLANT, and whose entire disclosure is incorporated by reference herein.

### BACKGROUND OF THE INVENTION

The invention concerns a method and a monitoring apparatus for monitoring a machine state of a machine system, in particular a wind power plant, a vehicle or a structure, on the basis of measured vibration data of the machine system. Applications of the invention are given in particular in the monitoring and detecting of disturbed operating states of wind power plants or other machine systems.

It is generally known to detect the state of machine systems by means of vibration measurements (see, for example, DE 103 00 947 A1 or DE 10 2018 119 679 A1). Machine operational vibrations and structural vibrations occur in a machine system, in particular a wind power plant. Machine operational vibrations are resonantly excited by periodically moving, in particular rotating, components of the machine system. The frequency range of the machine operational vibrations (typically in the Hz to kHz range) is determined by the operating frequencies of the machine system and higher harmonics thereof. The structural vibrations are the natural frequencies (or: natural vibrations) of the machine system, which include all resonant vibrations except for the vibrations caused by dynamic excitation during machine operation and are typically below the operating frequencies of the machine system in the range from mHz to kHz. For example, natural vibrations of tower bendings of a wind power plant are within the range of 0.1 Hz to 10 Hz and torsional natural vibrations of a ship's propulsion shaft are within the range of 1 Hz to 100 Hz.

A wind power plant typically comprises a tower with a nacelle that carries a rotor and accommodates a generator for converting mechanical rotational energy of the rotor into electrical energy. Slow structural vibrations of a wind power plant comprise, for example, tower bending vibrations, which occur analogue to the two mechanical bending vibrations of a bar, and nacelle vibrations, which include in particular pitching vibrations, rolling vibrations laterally around the rotor axis and rotary vibrations, of which the first excited natural vibrations can also be measured in addition to the fundamental vibrations. Structural vibrations are excited by all forces acting on the wind power plant, so that stochastic forces (stochastic excitations), such as e.g. the wind load on the tower, generate random resonance curves which are characterized by random fluctuations of resonances under an envelope and whose average amplitudes as a function of frequency are usually Breit-Wigner curves (Lorentz curves), wherein the current realizations are subject to strong random local fluctuations.

Mechanical changes to the structure of a machine system affect the structural vibrations, in particular by changing the mean amplitudes of natural frequencies and/or deforming the spectrum of structural vibrations. For example, a bolt for fastening the nacelle to the tower of a wind power plant can crack, which changes the nacelle vibrations. The growth of a crack has an effect of a time-dependent deformation of the spectrum of structural vibrations.

There is therefore an interest in detecting structural vibrations in order to recognize changes to the structure of a machine system at an early stage and, if necessary, to be able to carry out maintenance or repair measures in good time. Although it is known to analyze structural vibrations in simple structures, such as antenna masts, measured environmental data must also be taken into account (see DE 10 2018 119 679 A1). However, complex machine systems, such as wind power plants, are characterized by highly noisy spectra of the structural vibrations, which are also superimposed by systematic but rotational speed-dependent excitations of the machine dynamics, as can be seen in FIG. 3A as an example.

Such highly noisy spectra can be analyzed using conventional methods with very limited reliability, limited informative value, with a restriction to particularly pronounced changes and/or with the application of additional statistical expertise only, so that a need for maintenance or repair is not recognized or not recognized in good time. The limited informative value means, for example, that a statement about the type of damage or at least the cause of the damage (material ageing, bolt fractures or similar) is largely impossible. Another problem with conventional methods is that each spectrum only includes a short-term measurement with relatively constant environmental parameters and long-term changes to a machine system can be recognized to a limited extent only.

The above problems do not only occur in monitoring of wind power plants, but also in other machine systems, such as watercraft or bridges.

### SUMMARY

The objective of the invention is to provide an improved method and an improved monitoring apparatus for monitoring a machine state of a machine system, such as a wind power plant, based on measured vibration data of the machine system, which avoids limitations of conventional techniques. The monitoring method and the monitoring apparatus should be characterized in particular by increased reliability, improved sensitivity and/or increased informative value, enable simplified output of monitoring results and/or enable new or extended applications of vibration-based monitoring.

This objective is solved by a method and/or a monitoring apparatus for monitoring a machine state of a machine system, which comprise the features of the independent claims. Preferred embodiments and applications of the invention are shown in the dependent claims.

According to a first general aspect of the invention, the above objective is solved by a method of monitoring a machine state of a machine system, in particular a wind power plant, with the steps comprising providing a time series of measured natural vibration spectra of the machine system, detecting a deformation parameter in at least one monitoring time interval, wherein the deformation parameter is characteristic of a deviation of the measured natural vibration spectra from a reference natural vibration spectrum of at least one reference machine system, detecting a noise parameter at the at least one monitoring time interval, wherein the noise parameter is characteristic of a noise of the measured natural vibration spectra, and determining the machine state from the deformation parameter and the noise parameter.

According to a second general aspect of the invention, the above objective is solved by a monitoring apparatus which is configured for monitoring a machine state of a machine system, in particular a wind power plant, and which comprises a measuring device being configured for providing a time series of measured natural vibration spectra of the machine system, an analyzing device being configured for detecting a deformation parameter, which is characteristic of a deviation of the measured natural vibration spectra from at least one reference natural vibration spectrum of at least one reference machine system, in at least one monitoring time interval and for detecting a noise parameter, which is characteristic of a noise of the measured natural vibration spectra, in the at least one monitoring time interval, and an evaluation device being configured for determining the machine state from the deformation parameter and the noise parameter. Preferably, the monitoring apparatus or one of its embodiments is configured for performing the method according to the first general aspect of the invention or one of its embodiments.

According to preferred embodiments of the invention, the monitoring apparatus may comprise memory-programmable logic controllers, programmable logic controllers, and/or at least one FPGA (field programmable gated array) unit with which the analyzing device and the evaluating device are implemented.

Further independent subjects of the invention are a data processing apparatus comprising a computer device being configured for carrying out the method according to the first general aspect of the invention or one of its embodiments, in particular for detecting the deformation parameter and the noise parameter and determining the machine state, and a computer program product comprising instructions which, when the program is executed by a computer, cause the computer to carry out the method according to the first general aspect of the invention or one of its embodiments, in particular detecting the deformation parameter and the noise parameter and determining the machine state.

The machine system is preferably a wind power plant or other machine equipped with a periodically operating motor and/or generator, such as a ship, or a construction work that can be excited to vibrate with a periodically operating machine, such as a bridge, a building, in particular a tower, a dam or a tunnel structure.

The term “machine state” generally refers to the state of the mechanical configuration of the machine system, in particular to mechanical properties of the machine system at the time of monitoring the machine state, such as, for example, material properties, in particular strength and elasticity properties, of the machine system and/or its components, and/or structural properties, in particular the integrity of materials and/or connections of components, of the machine system, and/or the development over time of at least one of these properties. The machine state may include, for example, the property of at least one material and/or at least one component of the machine system to be free of embrittlement or cracks. Quantitative measures of the machine state are determined by the natural vibration spectra, by spectral characteristics of the natural vibration spectra, such as the position of maxima, the amplitudes of maxima, the spectral width of maxima and/or the spectral shape, and/or by stochastic characteristics of the natural vibration spectra and/or their development over time. The step of determining of the machine state of the machine system is based on the detecting of the deformation parameter and the noise parameter from at least one of these quantitative measures. Advantageously, the machine state of the machine system can be detected independently of its operating state, which characterizes the current machine operation, such as driving under partial load or full load.

The step of determining of the machine state of the machine system may include an output of status information, e.g. in text form and/or in graphic form and/or as an optical and/or visual signal, and/or a diagnosis of errors, in particular material and/or structural errors in the machine system. A fault-free and error-free machine state is also referred to as a regular or normal machine state. Deviations from the fault-free and error-free machine state are also referred to as an irregular or abnormal machine state. The monitoring of the machine system and in particular the determining of the machine state can take place intermittently, at selected times or uninterruptedly, continuously during the operation of the machine system.

Providing of the time series of measured natural vibration spectra of the machine system may preferably comprise a vibration measurement of vibration raw data with at least one vibration sensor, in particular adapted for detecting surface vibrations, particularly preferably a plurality of vibration sensors, such as at least one strain sensor and/or acceleration sensor, a conversion of the vibration raw data into amplitude spectra and a separation of the natural vibration spectra from a mostly noise-induced background and/or contributions of the typically speed-dependent machine dynamics.

Natural vibration spectra may include all frequencies or at least one frequency sub-range of the mechanical vibrations of the machine system except for the machine operational vibrations and their higher harmonics that are dynamically excited by the machine itself. The machine operational vibrations and their higher harmonics may be determined by predetermined operating parameters of the machine system or by a vibration measurement of the machine operational vibrations (speed measurement) during operation of the machine system. The optionally provided rotational speed measurement may be carried out continuously or at specific polling times.

Providing of the time series of measured natural vibration spectra comprises a separation of the natural vibrations from the raw data. The providing of the time series of measured natural vibration spectra may be provided locally directly at the machine system and/or via a data connection at a monitoring apparatus located remotely from the machine system.

The deformation parameter detected according to the invention is a quantitative deformation measure of the deviation of the natural vibration spectra from a reference natural vibration spectrum (standard spectrum) of one or more (e.g. up to 10 or more) reference machine system(s) in at least one monitoring time interval. The monitoring time interval is a time range (time window) from which detected natural vibration spectra are taken into account and which comprises the measurement times of the associated natural vibration spectra and optionally measurement pauses between the measurements. The measurement time of an individual natural vibration spectrum can be selected so that, for example, a frequency range from 10-2 Hz to about 104 Hz and/or a time interval in the range from a few seconds to typically 10 minutes is covered. When monitoring tower vibrations in the frequency interval 0.1 Hz to 10 Hz, measurement times of e.g. 5 min to 10 min with a cycle rate of the individual vibration measurements of 0.01 seconds are useful for an acceptable resolution. The duration of the measurement pause can be up to 3 hours in each case, for example. A number of natural vibration spectra are measured in the monitoring time interval. The number of natural vibration spectra per monitoring time interval is selected so that the deformation parameter can be detected with sufficient statistical certainty. Preferably, 10 to 100, e.g. 40 to 60, natural vibration spectra are measured per monitoring time interval. The duration of the monitoring time interval is selected, for example, in the range from 3 hours to 2 days. With continued monitoring, the monitoring time interval is shifted as a sliding window with the ongoing monitoring along the time series of measured natural vibration spectra, so that sequences of time-varying spectra are created. The duration of continued monitoring can be months or years, for example.

The reference machine system can preferably be another machine system with the same or a similar mechanical configuration as the monitored machine system. A similar mechanical configuration is given, for example, if the reference machine system with the components thereof has predominantly an equal design and/or construction like the monitored machine system. The reference machine system or one of several reference machine systems can, in particular, be the monitored machine system itself in a regular machine state in the past. The reference machine system is characterized by the fault-free and error-free machine state, in particular by vibration properties during intended operation, without stochastic external force effects, such as gusts of wind.

Alternatively, the (or one of the) reference machine system(s) may comprise an idealized, error-free machine system. Accordingly, the deformation parameter may represent a deviation of an arithmetically averaged resonance curve of the monitored machine system from a standard shape (e.g. Breit-Wigner shape).

The deformation parameter can be determined as the deviation of the natural vibration spectra from a reference natural vibration spectrum by arithmetically calculating a difference between the spectra. The reference natural vibration spectrum (standard spectrum) of several reference machine systems can be calculated by arithmetic averaging or, in the case of reference machine systems characterized by slight technical differences, by a weighted averaging of the reference natural vibration spectra of the reference machine systems. Alternatively, the spectra of the reference machine systems can also be considered as fixed points in a function space (Hilbert space), so that the change in the distances of a vibration spectrum of the analyzed machine system to these spectra can be used as a measure of the machine state of the plant in question and thus as a deformation parameter.

In particular, a reference natural vibration spectrum can be based on historical data of the other and/or the monitored machine system under the assumption that these were recorded in a regular machine state. This assumption can be based, for example, on a user-based decision or on a numerical analysis of reference natural vibration spectra from the past and selection of a set of identical reference natural vibration spectra.

The deformation parameter quantitatively represents the extent to which the natural vibration spectrum deviates from the reference natural vibration spectrum and thus represents a distance measure to the reference systems or historical states of the system under consideration.

The reference natural vibration spectrum is characterized by lower noise than the natural vibration spectra. The noise parameter (disorder parameter) detected according to the invention is a quantitative disorder measure that characterizes the stability and statistical reliability of the temporal development of the natural vibration spectra. The noise parameter is generally smaller in regular operation than in irregular operation, i.e. the noise parameter increases when natural vibrations, e.g. due to mechanical instabilities, are more strongly excited than in regular operation and, in particular, the spectral width of the maxima at the natural frequencies increases.

Advantageously, with the deformation parameter and the noise parameter, the inventor has found a combination of two mathematically meaningful indicators that together allow a reliable and reproducible, optionally automatable, quantitative evaluation of the natural vibration spectra. For each monitoring time interval, the noise parameter provides an information about the noise in the natural vibration spectrum, e.g. due to stochastic external influences. The noise parameter improves an evaluation of the deformation parameter to the effect that changes in the natural vibration spectra can be more reliably attributed to non-critical stochastic effects or to the structural changes of the machine system that are being sought. In other words, a deformation of the natural vibration spectra caused by non-critical noise does not only lead to determining an irregular machine state. The deformation parameter and the noise parameter react to small changes in the natural vibration spectra, so that irregular operating states can be measured with increased sensitivity and reliability compared to conventional methods.

Another advantage is that the deformation parameter and the noise parameter are generally valid indicators that are detected on a functional-theoretical or functional-analytical (mathematical) basis and do not necessarily depend on learning data or expert knowledge. The indicators react to deviations from the typical appearance of the natural vibration spectra and to increased measurement inaccuracies. Other errors in the machine system, such as sensor or machine defects, can also be detected and may trigger an alarm. The deformation parameter and the noise parameter allow a simplified output of monitoring results.

According to a preferred embodiment of the invention, the deformation parameter may comprise a distension of an amplitude-time function of the measured natural vibration spectra in at least one interval of vibration frequencies with respect to a reference amplitude-time function of the reference natural vibration spectra of the at least one reference machine system in the at least one interval of vibration frequencies.

According to a further preferred embodiment of the invention, the noise parameter may comprise a distension of an amplitude-time function of the measured natural vibration spectra in at least one interval of vibration frequencies with respect to a smoothed amplitude-time function of the measured natural vibration spectra in the at least one interval of vibration frequencies.

The interval of vibration frequencies considered when calculating the distension for determining the deformation or noise parameter is selected so that it contains a maximum (peak) of the natural vibration spectrum. If the natural vibration spectrum comprises several maxima, i.e. several characteristic natural vibrations, the distension is determined accordingly in several intervals of vibration frequencies, each of which contains one of the maxima. The calculation in one single interval of vibration frequencies at one single maximum of the natural vibration spectrum can be provided, for example, if only one single natural vibration is excited and/or is sufficient for assessing the machine state of the machine system (e.g. if only one natural vibration of the nacelle is to be monitored) and/or if a greater risk of error can be tolerated when assessing the machine state of the machine system.

The distension is a quantitative measure of the distortion of the amplitude-time function, in particular including a scaling (increase or decrease), a stretching (or compression) and/or an inflation of the amplitude-time function. The detecting of the distension can include calculating a distance, such as a Euclidean distance, a Hamming distance or another distance measure, between the amplitude-time function and the reference amplitude-time function or the smoothed amplitude-time function at the predetermined vibration frequencies for each measured natural vibration spectrum of the time series and summing the distances over the time series. The distension can be determined in particular as described, for example, in “Control Theory in Physics and other Fields of Science” by Michael Schulz (Springer, 2005) or in “Computational Intelligence” by Rudolf Kruse et al. (Vieweg+Teubner, 2011).

The detecting of the distension of the amplitude-time function of the measured natural vibration spectra for determining the deformation parameter and/or the noise parameter has the advantage that the distension provides the deformation parameter and/or the noise parameter with particularly high sensitivity and reliability.

Advantageously, the detecting of the deformation parameter and the noise parameter and the determining of the machine state of the machine system can be repeated continuously at respective new monitoring time interval with the providing of each current measured natural vibration spectrum of the time series of measured natural vibration spectra. This embodiment of the invention can have particular advantages for continuous monitoring of a machine system, in particular a wind power plant.

Preferably, the analyzing device of the monitoring apparatus may be configured to detect the distension for determining the deformation parameter and/or the noise parameter, e.g. continuously.

According to a further advantageous variant of the invention, the providing of each natural vibration spectrum of the time series of the measured natural vibration spectra may comprise the steps of measuring vibration raw data with a plurality of vibration sensors arranged on the machine system for vibration measurement, converting the vibration raw data into vibration spectra of the machine system, the vibration spectra including dynamically excited machine vibrations and natural vibrations of the machine system, and filtering the vibration spectra for eliminating the dynamically excited machine vibrations, thereby obtaining the measured natural vibration spectra.

The vibration sensors are part of the measuring device of the monitoring apparatus. A conversion device of the monitoring apparatus can be configured for converting the vibration raw data, and a filter device of the monitoring apparatus can be configured to filter the vibration spectrum.

Furthermore, a smoothing of the filtered vibration spectrum can be optionally provided. The smoothing can be carried out by repeatedly measuring the natural vibration spectra, in the case of wind power plant for example over a period of up to 4 hours, and averaging the natural vibration spectra. Advantageously, smoothing reduces the effects of the wind on the natural vibration spectra.

The number of vibration sensors can be selected depending on the specific application conditions and the monitoring task. In the case of a wind power plant, at least 5, preferably 8 to 15 vibration sensors are used for vibration measurement, which are arranged, for example, on the main bearing, on the generator, on the tower and in the gear stages of the generator gearbox.

Particularly preferably, the filtering of the vibration spectrum can include the application of a Kalman filter to the vibration spectra. The Kalman filter is a time series filter that is applied to amplitude-time functions at predetermined frequencies of consecutive natural vibration spectra. The Kalman filter is constructed, for example, as described in “Control Theory in Physics and other Fields of Science-Concepts, Tools, and Applications” by Michael Schulz (Springer, 2005) or in “Optimal Control” by Arturo Locatelli (Birkhäuser, 2001). The Kalman filter, which can be a discrete-time or continuous filter, for example, distinguishes between the observation errors caused by measurement technology and the deviations in the machine and structural dynamics resulting from disturbances or noise influences and can therefore eliminate random influences from the vibration spectra particularly well. Advantageously, the Kalman filter is therefore highly effective in eliminating noise contributions as well as residuals of the machine dynamics (machine operational vibrations, i.e. rotational speed and higher harmonics) from the natural vibration spectra.

Alternatively, the providing of each natural vibration spectrum of the time series of the measured natural vibration spectra may be performed while no machine vibrations are periodically excited with the machine of the machine system. In this embodiment of the invention, providing each natural vibration spectrum may thus comprise measuring vibration raw data with a plurality of vibration sensors arranged on the machine system for vibration measurement while the machine system is in a state without dynamically excited machine vibrations, and converting the vibration raw data into vibration spectra of the machine system, the vibration spectra forming the measured natural vibration spectra. The state without dynamically excited machine vibrations is given, for example, when a machine system is switched off, e.g. a wind power plant is at a standstill or in spin mode, or a machine system without an exciting machine is being monitored.

Also in the case of the non-dynamically periodically excited machine system, an optional smoothing and/or filtering of the vibration spectra can be provided, which comprises the application of the Kalman filter to the vibration spectrum, whereby an additional smoothing of the natural vibration spectra is advantageously achieved.

According to a particularly preferred embodiment of the invention, determining a multidimensional evaluation parameter from the deformation parameter and the noise parameter is provided, wherein the machine state is determined from the multidimensional evaluation parameter. Advantageously, determining the multi-dimensional evaluation parameter facilitates determining the machine state of the machine system. The multidimensional evaluation parameter allows an immediate evaluation of whether a machine state is regular or irregular or whether a critical intermediate state is present.

Preferably, the monitoring apparatus may include an evaluation device configured for determining the multidimensional evaluation parameter from the deformation parameter and the noise parameter and for determining the machine state from the evaluation parameter.

Advantageously, various options are available for detecting the multidimensional evaluation parameter. According to a first variant, the evaluation parameter can comprise a position of the deformation parameter and the noise parameter, which are detected at a common monitoring time interval, in an at least two-dimensional evaluation field. The evaluation field is, for example, a flat map with two coordinates, which are represented by the deformation parameter and the noise parameter. For example, a Cartesian coordinate system can be provided, the axes of which represent the deformation parameter and the noise parameter. Alternatively, other coordinate systems can be used and/or a higher-dimensional evaluation field (higher-dimensional coordinate system) can be realized by including other current status parameters of the machine system, such as SCADA data (control data) collected for monitoring energy plants and/or information from the plant control system and/or available environmental data or similar, such as the oil temperature of gear oil, a reactance of the generator, a rotational speed of the generator, the position of rotor blades and/or weather data.

The evaluation parameter provides a current position and, preferably with continuous monitoring, a trajectory in the evaluation field. Different areas in the evaluation field can, for example, be assigned to a regular machine state or an irregular machine state or optionally also to a critical intermediate state. The machine state can be determined by detecting the position or optionally the trajectory in one of the areas in the evaluation field.

Furthermore, various portions of areas in the evaluation field, which represent an irregular machine state or optionally a critical intermediate state, can be assigned to certain errors in the machine system or its components, so that the current position and preferably the trajectory in the evaluation field also enables a diagnosis of which components of the machine system are experiencing an irregularity. This diagnosis can, for example, be based on reference measurements on comparable systems and/or empirical values.

Alternatively or additionally, according to a further variant, the evaluation parameter can comprise an at least two-dimensional functional of the deformation parameter and the noise parameter, which are detected at a common monitoring time. Advantageously, the functional allows the immediate classifying of the machine state as regular or irregular or optionally as a critical intermediate state.

According to a further particularly preferred embodiment of the invention, the determination of the machine state can comprise a classifying of the evaluation parameter, e.g. with a classification device of the monitoring apparatus, by a comparison with predetermined parameter ranges, e.g. the areas in the evaluation field or predetermined value range intervals of the functional, and an outputting of the machine state, e.g. with an output device of the monitoring apparatus, depending on the result of the classifying. The output of the machine state can, for example, be in text form or in graphic form or as an optical and/or visual signal, in particular an alarm, and/or include a diagnosis of errors in the machine system.

Advantageously, the classifying allows a splitting of the set of machine system states into at least two, e.g. two, three or more subsets, such as normal, critical, alarm. For example, all known or recognisable anomalies can be verified as critical and/or alarm-worthy and all operating states that appear normal can be assigned to the normal class.

### BRIEF DESCRIPTION OF THE DRAWINGS

Further details and advantages of the invention are described below with reference to the enclosed figures. The figures show schematically in:

FIG. 1: features of methods for monitoring a machine state of a machine system according to embodiments of the invention;

FIG. 2: features of apparatuses for monitoring a machine state of a machine system according to embodiments of the invention;

FIG. 3: examples of practical applications of the invention; and

FIG. 4: a visualization of an evaluation parameter in a two-dimensional evaluation field.

### DETAILED DESCRIPTION

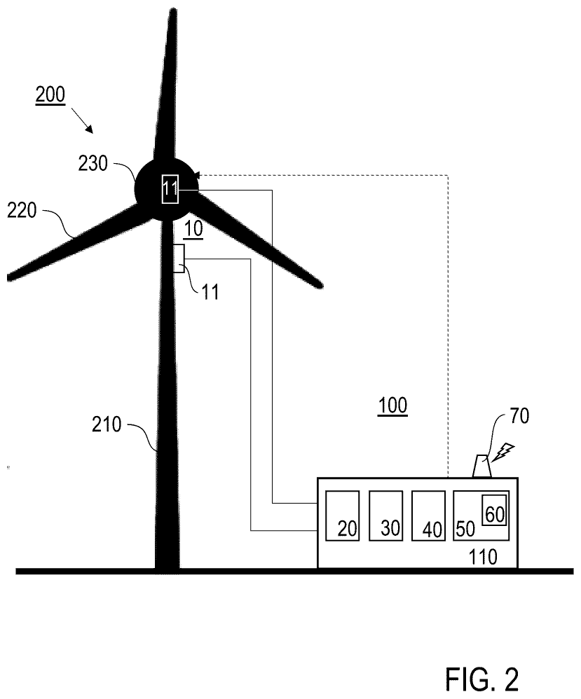

Features of embodiments of the invention are described below with exemplary reference to the monitoring of a wind power plant 200, which is shown schematically in FIG. 2 and comprises a tower 210, a rotor 220 and a nacelle 230. The wind power plant 200 is provided with a plurality of vibration sensors 11, each of which provides a measuring channel of the measuring device 10 of the monitoring apparatus 100 according to FIG. 2. The application of the invention is not limited to the monitoring of a wind power plant, but is correspondingly possible with other machine systems. Properties of wind power plants, their operation, in particular control, and vibration measurement on wind power plants are not explained, insofar as these are known per se from conventional wind power plants.

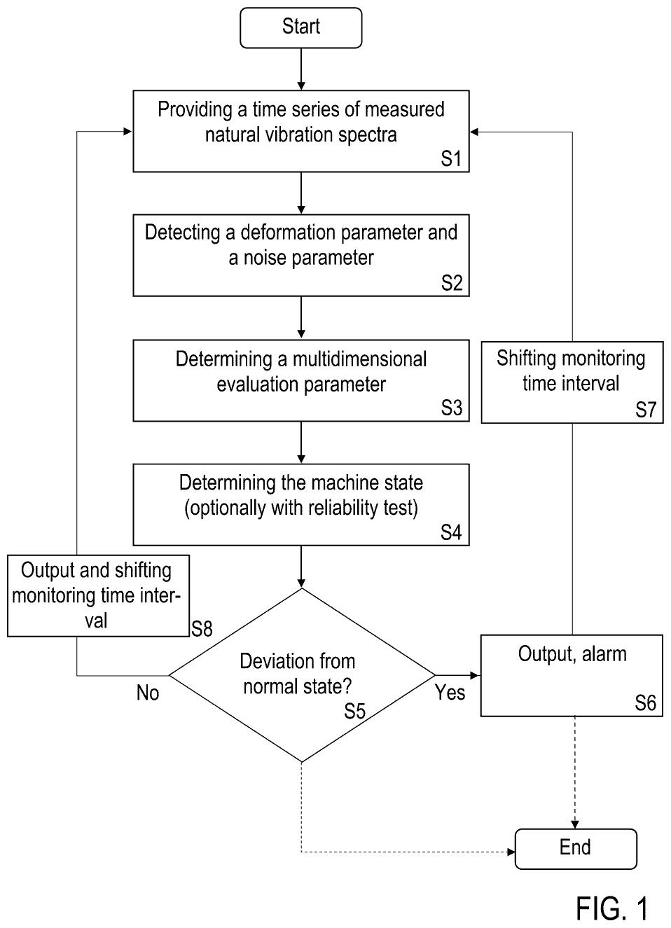

FIG. 1 shows a flowchart with steps of the method for monitoring the machine state of the wind power plant 200, wherein according to various embodiments of the invention, all steps in combination or a part of the steps (e.g. the method shown without step S3) or additional steps (e.g. for reliability assessment) may be provided, as explained below. The method is preferably carried out continuously during operation of the wind power plant 200, i.e. vibration raw data collected over years of service life can be analyzed and used for monitoring.

The method shown in FIG. 1 is carried out for at least one of the vibration sensors 11 in each case. One single vibration sensor 11 can be used for monitoring, or several or all vibration sensors 11 can be used separately for monitoring. Each of the vibration sensors 11 may be arranged for detecting a different structural vibration of the wind power plant 200. An irregular machine status of the wind power plant 200 can be recognized if the evaluation of the vibration data from at least one of the vibration sensors 11 results in the detection of a disturbance or if the evaluation of the vibration data from several or all of the vibration sensors 11 results in the detection of disturbances. The vibration sensors 11 of the measuring device 10 are used to measure vibration raw data. The vibration sensors 11 are read out at a sampling rate of approximately 103 Hz, whereby approximately 107 measurement points are detected per amplitude spectrum raw data set.

The method according to FIG. 1 is preferably carried out with the monitoring apparatus 100 shown schematically in FIG. 2, which comprises the measuring device 10 with the vibration sensors 11, a conversion device 20, a filter device 30, an analyzing device 40, an evaluation device 50 with a classification device 60, and an alarm device 70. The conversion device 20, the filter device 30, the analyzing device 40 and the evaluation device 50 are preferably provided by one or more computer units, such as one or more FPGAs. A conversion device 20, a filter device 30, an analyzing device 40 and an evaluation device 50 can be provided separately for each measurement channel, i.e. for each vibration sensor 11. Alternatively, the conversion device 20, the filter device 30, the analyzing device 40 and the evaluation device 50 may each contain separate data processing channels for the measurement channels. The alarm device 70 comprises, for example, at least one visual alarm and/or at least one audio alarm. Different alarm signals can be provided for different errors, e.g. on different components of the wind power plant 200, and/or different measurement channels.

According to FIG. 1, the monitoring of the wind power plant 200 initially comprises a step S1 of providing a time series of measured natural vibration spectra of the wind power plant 200. The time range covered by the detected time series of measured natural vibration spectra is also referred to as the monitoring time interval. The detecting of the deformation parameter and the noise parameter that follows in step S2 refers to the monitoring time interval, which is selected, for example, in the range from 3 hours to 2 days. During ongoing monitoring, the monitoring time interval is shifted by a predetermined step width, e.g. by 3 to 4 hours, after each run (cycle) of the procedure (see step S8 below).

In step S1, a conversion of the vibration raw data into vibration spectra of the wind power plant 200 is carried out by the conversion device 20. The conversion comprises a frequency-amplitude analysis of the vibration raw data and the formation of data sets, each of which represents a vibration spectrum. Each vibration spectrum initially contains dynamically excited machine vibrations, i.e. the periodic excitations due to the speed of the generator, and the natural vibrations of the wind power plant 200.

The extracting of the natural vibrations of the wind power plant 200 from the vibration spectrum data sets is carried out with the filter device 30 in step S1, as the monitoring of the wind power plant 200 according to the invention is based on the qualitative evaluation of the natural vibrations. The dynamically excited vibrations and their higher harmonics are eliminated with the filter device 30. The filtering of the vibration spectra is based, for example, on a FFT (Fast Fourier Transformation) application (known per se) and a subtraction of the dynamically excited machine vibrations and the higher harmonics in frequency space. The frequency of the dynamically excited machine vibrations is generally known from the operating conditions of the machine system and in particular from a rotational speed measurement on the generator of the wind power plant 200.

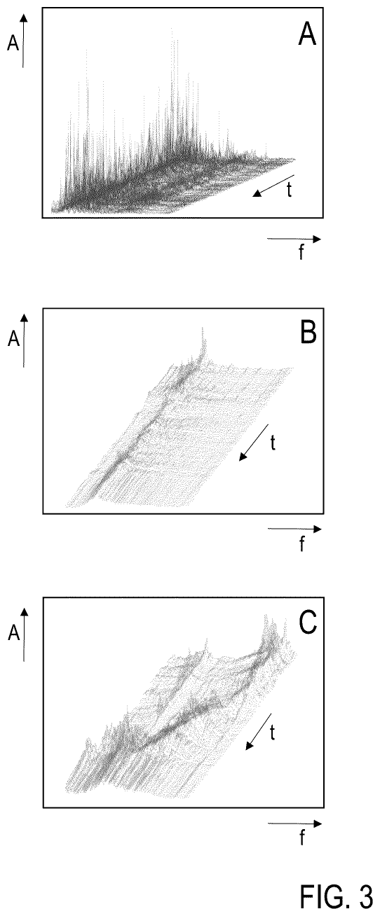

As a result of filtering out the dynamically excited machine vibrations, a time series of measured natural vibration spectra is provided, as shown by way of example in FIG. 3A, where f represents a linear frequency axis with frequencies, for example, in the range from 0 Hz to 1 kHz, A represents a linear amplitude axis of the vibration amplitudes occurring at the frequencies (relative units) and t represents a linear time axis over a period of, for example, 250 days (duration of continued monitoring). The monitoring time interval is e.g. 1 day. FIG. 3A illustrates by way of example that the temporal evolution of measured natural vibration spectra is initially still characterized by noise, which would make it difficult to derive irregularities directly from the natural vibration spectra.

Amplitude-time functions being initially unsmoothed are obtained from the natural vibration spectra at a large number of specified frequencies. Each amplitude-time function comprises amplitudes of the natural vibration spectra at the respective specified frequency in the monitoring time interval. In the detected frequency range, for example, 8 frequencies are selected, for each of which a data set is determined that represents the associated amplitude-time function.

For reducing the noise, a smoothing of the natural vibration spectra, in particular the amplitude-time functions of the natural vibration spectra, is preferably carried out with the filter device 30 by applying a Kalman filter to the amplitude-time functions of the vibration spectra. The Kalman filter is applied as a time series filter to each amplitude-time function, wherein noise is eliminated and a smoothed signal of highest probability is determined as the smoothed amplitude-time function.

After applying the Kalman filter, the natural vibration spectra with reduced noise can be recovered from the smoothed amplitude-time functions. As a result of filtering with the Kalman filter, a time series of measured natural vibration spectra with significantly reduced noise is thus provided, as shown by way of example in FIG. 3B or 3C.

FIGS. 3B and 3C illustrate the advantageous effect of smoothing the natural vibration spectra with the Kalman filter. In contrast to the very noisy image in FIG. 3A, natural vibrations and their development over time are clearly recognizable. According to FIG. 3B, the natural vibration comprises an essentially constant frequency and relatively little change in amplitude, which allows a regular machine state of the wind turbine 200 to be recognized. According to FIG. 3C, the natural vibration splits into two partial vibrations, with the frequency of the new split-off natural vibration changing over time, which allows a change in the mechanical configuration and thus an irregular machine state of the wind power plant 200 to be detected.

Subsequently, at step S2, the deformation parameter of the natural vibration spectra as a distension of the smoothed amplitude-time functions of the natural vibration spectra in an interval of vibration frequencies around one or more maxima of the natural vibration spectra with respect to a reference amplitude-time function of a reference natural vibration spectrum of at least one reference wind power plant in the interval of vibration frequencies is determined with the analyzing device 40.

Furthermore, in step S2, the noise parameter of the natural vibration spectra as a distension of the unsmoothed amplitude-time functions of the natural vibration spectra in the interval of vibration frequencies around the one or more maxima of the natural vibration spectra in relation to the previously calculated smoothed amplitude-time function of the measured natural vibration spectra in the interval of vibration frequencies is determined with the analyzing device 40.

For calculating the distension, the deviations (distances) of the smoothed amplitude-time functions from the reference amplitude-time function or the deviations of the unsmoothed amplitude-time functions from the smoothed amplitude-time function are summed up.

With a greater change in the smoothed amplitude-time functions in relation to the reference amplitude-time function, a greater distension or a greater deformation parameter is determined than with a smaller change in the smoothed amplitude-time functions. Accordingly, the deformation parameter directly provides a measure of the change in the natural vibration spectra in the monitoring time interval. Furthermore, a stronger noise of the unsmoothed amplitude-time functions in relation to the smoothed amplitude-time function results in a greater distension or a greater noise parameter than with a lower noise. Accordingly, the noise parameter directly provides a measure of the stochastic disorder of natural vibration spectra in the monitoring time interval.

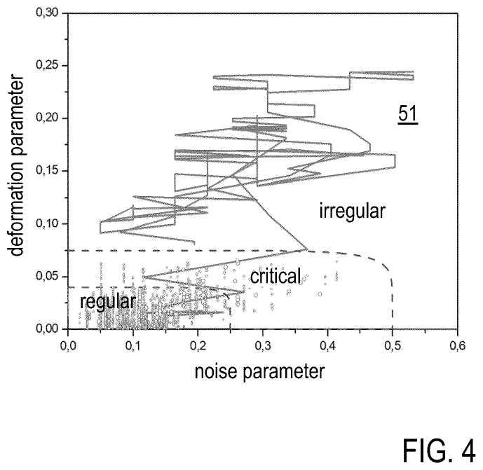

In the optionally provided step S3, the evaluation device 50 is used to determine a multi-dimensional evaluation parameter from the noise and deformation parameters. An example of the evaluation parameter is the position in a two-dimensional evaluation field 51, as shown schematically in FIG. 4. The dimensions of the evaluation field 51 are the noise and deformation parameters. The evaluation parameter is given by the position of the current noise and deformation parameters in the evaluation field 51, and it can be displayed on a display of the monitoring apparatus 100. Step S3 is not mandatory. The noise and deformation parameters may also be used directly for determining the machine state of the wind power plant 200. Furthermore, another evaluation parameter can be used, such as a functional based on the noise and deformation parameters.

Subsequently, the current machine state of the wind power plant is determined in step S4 by subjecting the evaluation parameter to a classifying process using the classification device 60. For example, it is determined whether the current evaluation parameter falls into one of the 3 areas “Regular”, “Critical” or “Irregular” of the evaluation field 51 (see FIG. 4).

In addition to the classifying, a reliability assessment can be carried out in step S4. A reliability measure is determined, which is used, for example, to quantify the probability of error of the evaluation parameter. For example, the deviation of the error distribution of the measured machine system from the error distribution of the reference machine systems estimated according to the Kolmogorov-Smirnov method can be used as a reliability measure. The reliability measure allows appropriate measures to be taken on the wind power plant 200 in response to the detection of a critical or irregular machine state. For example, in the event of an alarm with a high probability of error, the operation of the wind power plant 200 can first be continued automatically in order to verify the current monitoring result, or an emergency shutdown of the wind power plant 200 can be provided in the event of a low probability of error.

If a deviation from the normal state is detected in step S5, i.e. if the evaluation parameter falls in particular into the “Critical” or “Irregular” range of the evaluation field 51, step S6 is followed by an output of the result of the determining of the machine state and an alarm with the alarm device 70. The alarm with the alarm device 70 may include various signals depending on the detected state. Subsequently, regardless of the alarm, the monitoring of the wind power plant 200 can be continued by shifting the monitoring time interval S7 and restarting the method with step S1 with the updated monitoring time interval. Alternatively, in particular in the event of an alarm-induced termination of operation of the wind power plant 200, the method can be terminated.

In response to the alarm, for example, a detailed analysis of the vibration data, a change in the operating conditions of the wind power plant 200 (possibly with a shutdown) and/or maintenance of the wind power plant 200 by maintenance personnel may be provided.

Alternatively, if no deviation from the normal state is detected in step S5, i.e. if the evaluation parameter falls within the “Regular” range of the evaluation field, no alarm follows, but instead, with step S8, an output of the result of determining the machine status and a shifting of the monitoring time interval as well as the jump to step S1 with the updated monitoring time interval. Alternatively, the method can be terminated, in particular in the event of a scheduled termination of operation of the wind power plant 200.

The output of the result of determining the machine state in step S6 or S8 can, for example, be in text form or preferably in the form of a color signal. The operating history can, for example, be shown on a display of the monitoring apparatus 100 or a separate control unit of the wind power plant 200 as a continuous strip with a color code, with different colors indicating different operating states.

The features of the invention disclosed in the above description, the drawings and the claims can be of importance both individually and in combination or sub-combination for the realization of the invention in its various embodiments.

What is claimed is:

1. A method for monitoring a machine state of a machine system, comprising:
providing a time series of measured natural vibration spectra of the machine system,
detecting a deformation parameter in at least one monitoring time interval, wherein the deformation parameter is characteristic of a deviation of the measured natural vibration spectra from a reference natural vibration spectrum of at least one reference machine system,
detecting a noise parameter at the at least one monitoring time interval, wherein the noise parameter is characteristic of a noise of the measured natural vibration spectra, and
determining the machine state from the deformation parameter and the noise parameter.

2. The method according to claim 1, wherein
the deformation parameter comprises a distension of an amplitude-time function of the measured natural vibration spectra in an interval of vibration frequencies with respect to a reference amplitude-time function of a reference natural vibration spectrum of the at least one reference machine system in the interval of vibration frequencies.

3. The method according to claim 1, wherein
the noise parameter comprises a distension of an amplitude-time function of the measured natural vibration spectra in an interval of vibration frequencies with respect to a smoothed amplitude-time function of the measured natural vibration spectra in the interval of vibration frequencies.

4. The method according to claim 1, wherein
the detecting of the deformation parameter and the noise parameter and the determining of the machine state are repeated continuously at respective new monitoring time intervals with the providing of each current measured natural vibration spectrum of the time series of measured natural vibration spectra.

5. The method according to claim 1, wherein the providing of each natural vibration spectrum of the time series of the measured natural vibration spectra comprises:
measuring vibration raw data with a plurality of vibration sensors arranged for vibration measurement on the machine system,
converting the vibration raw data into vibration spectra of the machine system, the vibration spectra including dynamically excited machine vibrations and natural vibrations of the machine system, and
filtering the vibration spectra for eliminating the dynamically excited machine vibrations, whereby the measured natural vibration spectra are obtained.

6. The method according to claim 5, wherein
the filtering of the vibration spectra comprises applying a Kalman filter to the vibration spectra.

7. The method according to claim 1, wherein the step of providing of each natural vibration spectrum of the time series of the measured natural vibration spectra comprises:
measuring vibration raw data with a plurality of vibration sensors arranged for vibration measurement on the machine system while the machine system is in a state without dynamically excited machine vibrations, and
converting the vibration raw data into vibration spectra of the machine system, the vibration spectra forming the measured natural vibration spectra.

8. The method according to claim 7, further including
filtering the vibration spectra, which comprises applying a Kalman filter to the vibration spectra.

9. The method according to claim 1, further including
determining a multidimensional evaluation parameter from the deformation parameter and the noise parameter, wherein the machine state is determined from the multidimensional evaluation parameter.

10. The method according to claim 9, wherein the multidimensional evaluation parameter comprises at least one of:
a position of the deformation parameter and the noise parameter, detected at a common monitoring time interval, in an at least two-dimensional evaluation field, and
an at least two-dimensional functional of the deformation parameter and the noise parameter, which are detected at a common monitoring time.

11. The method according to claim 9, wherein the determining of the machine condition comprises:
classifying the evaluation parameter by a comparison with predetermined parameter ranges, and
outputting the machine state as a function of the result of the classifying.

12. The method according to claim 1, wherein
the machine system comprises a wind power plant.

13. A monitoring apparatus, which is configured for monitoring a machine state of a machine system, comprising:
a measuring device, which is configured for providing a time series of measured natural vibration spectra of the machine system,
an analyzing device, which is configured for detecting a deformation parameter, which is characteristic of a deviation of the measured natural vibration spectra from at least one reference natural vibration spectrum of at least one reference machine system, in at least one monitoring time interval and for detecting a noise parameter, which is characteristic of a noise of the measured natural vibration spectra, in the at least one monitoring time interval, and
an evaluation device configured for determining the machine state from the deformation parameter and the noise parameter.

14. The monitoring apparatus according to claim 13, wherein
the analyzing device is configured to detect, as the deformation parameter, a distension of an amplitude-time function of the measured natural vibration spectra in an interval of vibration frequencies with respect to a reference amplitude-time function of the reference natural vibration spectra of the at least one reference machine system in the interval of vibration frequencies.

15. The monitoring apparatus according to claim 13, wherein
the analyzing device is configured to detect, as the noise parameter, a distension of an amplitude-time function of the measured natural vibration spectra in an interval of vibration frequencies from a smoothed amplitude-time function of the measured natural vibration spectra in the interval of vibration frequencies.

16. The monitoring apparatus according to claim 13, wherein
the analyzing device is configured to repeat the detecting of the deformation parameter and the noise parameter and the determining of the machine state continuously at respective new monitoring time intervals with the providing of each current measured natural vibration spectrum of the time series of measured natural vibration spectra.

17. The monitoring apparatus according to claim 13, further comprising:
a plurality of vibration sensors of the measuring device arranged to measure vibration raw data on the machine system,
a conversion device configured for converting the vibration raw data into a vibration spectrum of the machine system, wherein the vibration spectrum contains dynamically excited machine vibrations and natural vibrations of the machine system, and
a filter device configured for filtering the vibration spectrum for eliminating the dynamically excited machine vibrations, wherein the measured natural vibration spectrum is obtained.

18. The monitoring apparatus according to claim 17, wherein
the filter device is configured for filtering the vibration spectrum by applying a Kalman filter to the vibration spectrum.

19. The monitoring apparatus according to claim 13, further comprising:
a plurality of vibration sensors arranged to measure vibration raw data on the machine system while the machine system is in a state without dynamically excited machine vibrations, and
a conversion device configured for converting the vibration raw data into a vibration spectrum of the machine system, the vibration spectrum forming the measured natural vibration spectrum.

20. The monitoring apparatus according to claim 19, further comprising:
a filter device configured for filtering the vibration spectrum by applying a Kalman filter to the vibration spectrum.

21. The monitoring apparatus according to claim 13, further comprising:
an evaluation device configured for determining a multi-dimensional evaluation parameter from the deformation parameter and the noise parameter and for determining the machine state from the evaluation parameter.

22. The monitoring apparatus according to claim 21, further comprising:
a classification device configured for classifying the evaluation parameter by a comparison with predetermined parameter ranges, and
an output device configured for outputting the machine state depending on the result of the classifying.

23. The monitoring apparatus according to claim 13, further comprising at least one of:
memory-programmable logic controllers,
programmable logic controllers, and
an FGPA unit.

24. The monitoring apparatus according to claim 13, wherein
the monitoring apparatus is configured for monitoring a machine state of a wind power plant.

25. A data processing apparatus comprising a computer device configured for carrying out the method according to claim 1.

26. A computer program product comprising instructions which, when the computer program product is executed by a computer, cause the computer to execute the method according to claim 1.
